(19) United States
(12) Patent Application Publication
(10) Pub. No.: US 2026/0171046 A1
(43) Pub. Date: Jun. 18, 2026

(54) DISPLAY DEVICE AND DRIVING METHOD THEREFOR

(71) Applicant: SAMSUNG ELECTRONICS CO., LTD., Suwon-si (KR)

(72) Inventors: Jungmin KU, Suwon-si (KR); Sunghwan JANG, Suwon-si (KR)

(73) Assignee: SAMSUNG ELECTRONICS CO., LTD., Suwon-si (KR)

(21) Appl. No.: 19/535,503

(22) Filed: Feb. 10, 2026

Related U.S. Application Data
(63) Continuation of application No. PCT/KR2024/009201, filed on Jul. 1, 2024.

(30) Foreign Application Priority Data
Aug. 16, 2023 (KR) 10-2023-0106891

(51) Int. Cl. G09G 5/10; G09G 5/00

(52) U.S. Cl. CPC G09G 5/10; G09G 5/003; G09G 2300/026; G09G 2320/0233; G09G 2320/041; G09G 2320/0626; G09G 2320/0686; G09G 2330/021

(57) ABSTRACT

A modular display may comprise: a display unit including at least one display module; a storage for storing at least one instruction; and at least one processor for executing the at least one instruction. The at least one processor can calculate the load of a full screen on the basis of input image data, calculate a peak gain for output image luminance on the basis of the load, calculate the heating level of the at least one display module on the basis of the peak gain, and control the peak gain on the basis of the heating level of the at least one display module.

### CROSS-REFERENCE TO RELATED APPLICATIONS

This application is a by-pass continuation of International Application No. PCT/KR2024/009201 designating the United States, filed on Jul. 1, 2024, in the Korean Intellectual Property Receiving Office and claiming priority to Korean Patent Application No. 10-2023-0106891, filed on Aug. 16, 2023, in the Korean Intellectual Property Office, the disclosure of which is incorporated by reference herein in its entirety.

### TECHNICAL FIELD

The disclosure relates to a modular display device and a method for driving the modular display device.

### BACKGROUND ART

With the development of digital technology, various types of electronic devices are being used, such as smart TVs, smart phones, tablet PCs, electronic organizers, PDAs (personal digital assistants), or wearable devices. In particular, various types of electronic devices may be implemented as a display device that outputs an image to a display panel based on input data.

Recently, a modular display device combining a plurality of sub-display devices has been developed. The modular display device may be composed of a plurality of sub-display devices (e.g., a plurality of display modules), and each sub-display device may display a divided image which is a division of one overall image. Accordingly, the modular display device may display the overall image through a large-scale screen configured by the plurality of sub-display devices.

Upon displaying an image based on input data, a display device may adjust a gain for controlling a brightness of the image to prevent a decrease in display performance due to unnecessary power consumption and heat generation. For example, the display device may lower the brightness of the image by decreasing the gain when the load of the image is relatively high, and may increase the brightness of the image by increasing the gain when the load of the image is relatively low.

Meanwhile, in the modular display device, the divided image displayed by each sub-display device may vary depending on the arrangement and number of the sub-display devices. Accordingly, when the modular display device performs a batch gain adjustment on the basis of the overall image, a decrease in display quality may be caused due to unnecessary gain adjustment. Therefore, a solution is required for the modular display device to perform the gain adjustment based on the arrangement and number of the sub-display devices.

### SUMMARY

Various embodiments of the disclosure may provide a display device and a method for driving the display device for efficiently controlling heat generation of a display unit, by determining a heat generation level based on each display module, rather than collectively determining the heat generation level based on a full screen, and by adjusting the peak gain in consideration of the arrangement and number of the display modules.

A modular display device according to embodiments of the disclosure may include a display unit including at least one display module, a storage storing at least one instruction, and at least one processor configured to execute the at least one instruction. The at least one processor may be configured to calculate a load of a full screen based on input image data, calculate a peak gain for output image luminance based on the load, calculate a heat generation level of the at least one display module based on the peak gain, and control the peak gain based on the heat generation level of the at least one display module.

According to an embodiment, the at least one processor may be configured to predict whether the at least one display module exceeds a reference operating temperature by calculating the heat generation level in units of the at least one display module. The at least one processor may execute a gain limit algorithm when it is predicted that the at least one display module will exceed the reference operating temperature, based on the heat generation level.

According to an embodiment, the at least one processor may be configured to extract an average picture level (APL) for the full screen from the input image data, and calculate the load of the full screen based on the average picture level.

According to an embodiment, the at least one processor may be configured to calculate a normal gain that minimizes the output image luminance based on the load, and calculate a maximum gain that maximizes the output image luminance based on the load.

According to an embodiment, the at least one processor may be configured to extract a high luminance area of the at least one display module based on the peak gain, and calculate the heat generation level based on a size of the high luminance area.

According to an embodiment, the high luminance area may have a luminance in the range of 1000 nits to 2000 nits.

According to an embodiment, the at least one processor may be configured to execute a gain limit algorithm for controlling the peak gain when the size of the high luminance area exceeds 20% to 25% of the size of the at least one display module.

According to an embodiment, the at least one processor may be configured to control at least one of a maximum gain holding time, a gain control slope, or a gain limit, based on the heat generation level of the at least one display module.

According to an embodiment, the gain limit algorithm may be configured to decrease the maximum gain holding time as the number of the at least one display module including the high luminance area increases.

According to an embodiment, the gain limit algorithm may be configured to increase the gain control slope as the number of the at least one display module including the high luminance area increases.

According to an embodiment, the gain limit algorithm may be configured to decrease the gain limit as the number of the at least one display module including the high luminance area increases.

According to an embodiment, the at least one processor may be configured to extract at least one high luminance area included in at least one of four adjacent display modules, calculate a dispersion degree of the at least one high luminance area, and calculate the heat generation level of the at least one of the four adjacent display modules based on the dispersion degree.

According to an embodiment, the at least one processor may be configured to execute a gain limit algorithm for controlling the peak gain when a summed size of the at least one high luminance area included in the at least one of the four adjacent display modules exceeds 20% to 25% of the size of the at least one display module.

A method for driving a modular display device according to embodiments of the disclosure may include calculating a load of a full screen based on input image data, calculating a peak gain for output image luminance based on the load, calculating a heat generation level of at least one display module based on the peak gain, and controlling the peak gain based on the heat generation level of the at least one display module.

According to an embodiment, an operation of calculating the load of the full screen may include extracting an average picture level (APL) for the full screen from the input image data, and calculating the load of the full screen based on the average picture level.

According to an embodiment, an operation of calculating the peak gain for the output image luminance may include calculating a normal gain that minimizes the output image luminance based on the load, and calculating a maximum gain that maximizes the output image luminance based on the load.

According to an embodiment, an operation of calculating the heat generation level of the at least one display module may include extracting the high luminance area of the at least one display module based on the peak gain, and calculating the heat generation level based on the size of the high luminance area.

According to an embodiment, an operation of controlling the peak gain may execute a gain limit algorithm for controlling the peak gain when a size of the high luminance area exceeds 20% to 25% of the size of the at least one display module.

According to an embodiment, an operation of controlling the peak gain may control at least one of a maximum gain holding time, a gain control slope, and a gain limit, based on the heat generation level of the at least one display module.

According to an embodiment, an operation of calculating the heat generation level of the at least one display module may include extracting at least one high luminance area included in at least one of four adjacent display modules, calculating a dispersion degree of the at least one high luminance area, and calculating the heat generation level of the at least one of the four adjacent display modules based on the dispersion degree.

According to various embodiments of the disclosure, the display device and the driving method thereof may efficiently control heat generation of a display unit by determining the heat generation level on the basis of each display module, and adjusting the peak gain based on the arrangement and number of the display modules. Accordingly, the display device and the driving method thereof may prevent an unnecessary peak gain control, and minimize the decrease in the luminance of the full image and the decrease in display quality due to the peak control.

Effects that can be obtained from example embodiments of the disclosure are not limited to those mentioned above, and other effects not mentioned herein may be clearly derived and understood by those having ordinary knowledge in the technical field to which the example embodiments of the disclosure belong from the following description. In other words, any unintended effects of implementing example embodiments of the disclosure may also be derived by those having ordinary knowledge in the technical field from the example embodiments of the disclosure.

### BRIEF DESCRIPTION OF DRAWINGS

The subject-matter of the present disclosure is best understood with reference to the accompanying figures, in which:

FIG. 1 illustrates a block configuration of a display device,

FIG. 2 illustrates a perspective view of a display unit included in a display device,

FIG. 3 illustrates a detailed block configuration of a display device,

FIG. 4 illustrates an operation sequence of a display device,

FIG. 5 illustrates a display module including a high luminance area,

FIG. 6 illustrates a change in peak gain based on a gain limit algorithm,

FIG. 7 illustrates a change in peak gain based on a gain limit algorithm,

FIG. 8 illustrates an operation sequence of a display device,

FIG. 9 illustrates four adjacent display modules including a high luminance area.

### DETAILED DESCRIPTION

Hereinafter, embodiments of the disclosure will be described in detail with reference to the drawings such that a person having ordinary knowledge in the technical field to which the disclosure belongs may easily implement the embodiments. However, the disclosure may be implemented in various different forms and is not limited to the embodiments described herein. In relation to the description of the drawings, the same or similar reference numerals may be used for the same or similar components. Further, in the drawings and related description, the descriptions of well-known functions and configurations may not be reiterated for clarity and brevity.

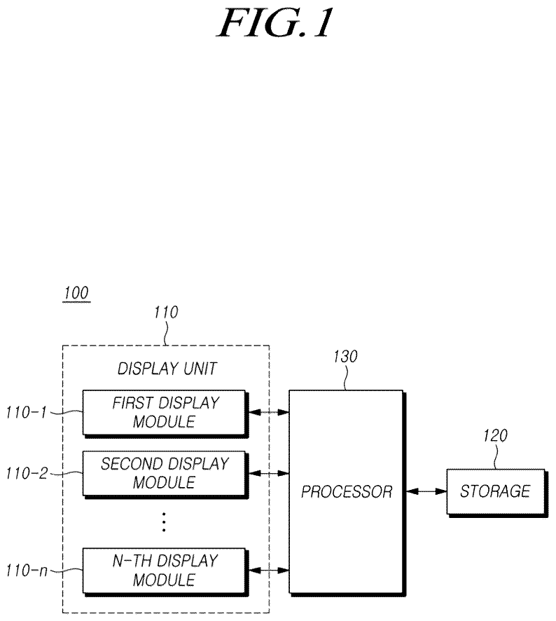

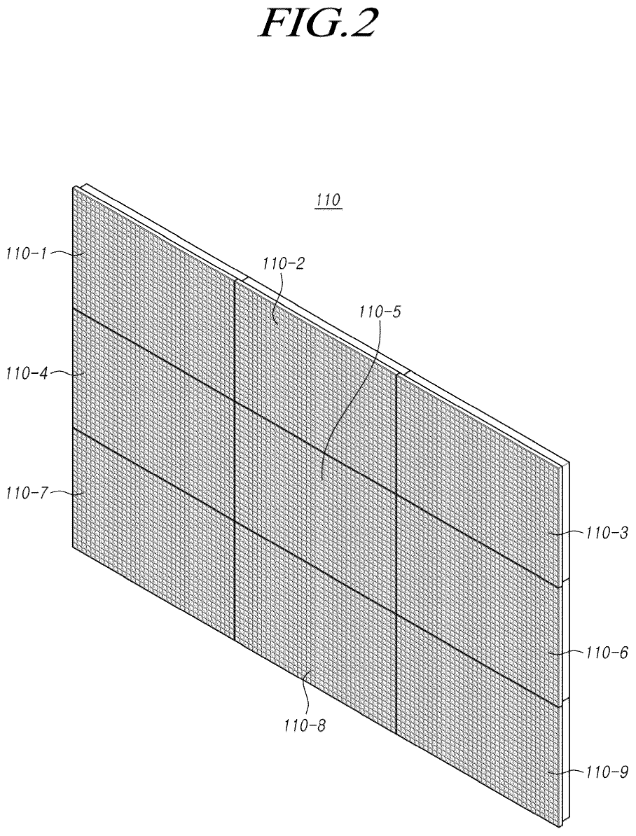

FIG. 1 illustrates a block configuration of a display device, and FIG. 2 illustrates a perspective view of a display unit included in a display device.

Referring to FIG. 1, a display device 100 may include a display unit 110, a storage 120, and a processor 130.

The display device 100 may display an image through the display unit 110. Here, the image displayed may include an input image received from any external device (e.g., set-top box, computer, server, etc.), or may include an image pre-stored in the display device 100.

The display unit 110 may display an image based on input image data. The display unit 110 may include at least one display module 110-1, 110-2, . . . , 110-n. Each of the at least one display module 110-1, 110-2, . . . , 110-n of the display unit 110 may display a split image which is a division of one image. For example, the display device 100 of the disclosure may be referred to as at least one of a modular display, a modular screen, a tiled display, a wall display, or a video wall.

Each of the at least one display module 110-1, 110-2, . . . , 110-n may include a sub-processor, a driver IC, at least one pixel composed of a plurality of light-emitting elements of different colors, and a power supply unit. For example, the sub-processor included in the at least one display module 110-1, 110-2, . . . , 110-n may receive input image data from the processor 130. The sub-processor may determine the input image data corresponding to the at least one display module 110-1, 110-2, . . . , 110-n based on identification information set in the at least one display module 110-1, 110-2, . . . , 110-n.

According to an embodiment, identification information (e.g., ID) corresponding to each display module may be assigned to the at least one display module 110-1, 110-2, . . . , 110-n. For example, ID1 may be set for a first display module 110-1. The sub-processor included in the first display module 110-1 may determine first input image data corresponding to ID1 of the input image data, and transmit the first input image data to the driver IC. In such a case, the driver IC of the first display module 110-1 may convert the first input image data into a first data current (or voltage), which is analog data, and supply the first data current (or voltage) to the at least one pixel to display a first image corresponding to the first input image data. Similarly, the second to n-th display modules 110-2, . . . , 110-n may display the second to n-th images corresponding to the second to n-th input image data based on the identification information (e.g., ID) corresponding to each display module.

As illustrated in FIG. 2, the display unit 110 may include at least one display module 110-1, 110-2, . . . , 110-n. For example, the display unit 110 may include a plurality of display modules (e.g., 110-1, 110-2, 110-3, 110-4, 110-5, 110-6, 110-7, 110-8, 110-9) that are physically connected to make up one display. Although the at least one display module is illustrated to be configured in a 3×3 arrangement (e.g., 9 modules) in FIG. 2, the arrangement and number of the at least one display module 110-1, 110-2, . . . , 110-n of the display unit 110 of the disclosure are not limited thereto. Here, the at least one display module 110-1, 110-2, . . . , 110-n may be referred to as least one of a sub-screen, a sub-module, a tile, and a cabinet.

The at least one display module 110-1, 110-2, . . . , 110-n may include at least one pixel. The at least one pixel may include a plurality of sub-pixels (e.g., red LED, green LED, and blue LED). For example, the plurality of sub-pixels (e.g., red LED, green LED, and blue LED) may include micro LEDs. Here, the micro LED may be an ultra-small light-emitting element that emits light by itself without a color filter, having a size of about 5 μm to 100 μm. For example, the at least one display module 110-1, 110-2, . . . , 110-n may be an LED display module including a plurality of micro LEDs.

Meanwhile, the at least one pixel may be electrically connected to the driver IC. Further, the driver IC may be electrically connected to a timing controller and may control light emission of the at least one pixel according to the control of the timing controller. For example, the timing controller may transmit input image data for the control of the at least one pixel to the driver IC. The driver IC may convert the input image data into analog data for the control of the at least one pixel, and may output a current or apply a voltage to the at least one pixel according to the analog data. The at least one pixel may emit light based on the current output by the driver IC or the voltage applied by the driver IC. To this end, the at least one display module 110-1, 110-2, . . . , 110-n may include a power supply unit (e.g., switched-mode power supply, SMPS) that supplies electric power.

Meanwhile, the above-described micro LED display module is an example of the at least one display module 110-1, 110-2, . . . , 110-n, and the at least one display module 110-1, 110-2, . . . , 110-n according to the disclosure may be implemented in various forms such as organic LED (OLED), active matrix OLED (AMOLED), quantum dot LED (QLED), and the like.

The storage 120 may store an operating system (OS) for controlling the operation of the display device 100 and instructions or data related to the operation of the display device 100.

For example, the processor 130 may control a plurality of hardware or software components of the display device 100 using various instructions or data stored in the storage 120. For example, the processor 130 may load and process instructions or data received from at least one of the other components into volatile memory, and store various data in non-volatile memory.

The storage 120 may be implemented as various types of storage media. For example, the storage 120 may be implemented as a non-volatile memory element such as ROM (Read Only Memory), PROM (Programmable Read Only Memory), EPROM (Erasable Programmable Read Only Memory), or flash memory, or a volatile memory element such as RAM (Random Access Memory), or a storage device such as a hard disk or an optical disc.

The storage 120 may store output luminance information for each gradation level according to brightness information of input image data. Here, the gradation level may be data of the brightness of each pixel included in the input image data being quantified as an integer. For example, an 8-bit image may be represented by a gradation level of 0 to 255. Further, an integer corresponding to the brightness of each pixel may be expressed as gradation value, brightness value, brightness code, or the like, but hereinafter, for convenience of description, it will be generally referred to as a gradation value.

Further, the brightness information of the input image data may be an average picture level (APL) for each frame of the input image data. For example, the APL may be an average gradation value for pixel data of one frame unit of the input image data. The display device 100 may display a relatively bright image as the APL increases, and may display a relatively dark image as the APL decreases. Further, the brightness of the image may also refer to various characteristics of pixels included in the image of the display device 100, such as a maximum gradation value, a mode gradation value, or the like, in addition to the APL.

The output luminance information for each gradation level may be the output luminance information for each gradation level of the input image data considering the power consumption of the display device 100. For example, the display device 100 may limit the output image luminance according to the brightness of the input image data in order to output the image within a maximum power consumption (or average power consumption). For example, the display device 100 may limit the output image luminance by applying a peak gain to the output luminance information for each gradation level.

The processor 130 may control the overall operation of the display device 100. Specifically, the processor 130 may drive an operating system or an application program to control hardware or software components connected to the processor 130, and perform various data processing and calculations. Further, the processor 130 may load and process instructions or data received from at least one of the other components into volatile memory, and store various data in non-volatile memory.

To this end, the processor 130 may include at least one of a digital signal processor (DSP), a central processing unit (CPU), a controller, an application processor (AP), a communication processor (CP), or an ARM processor. Further, the processor 130 may be electrically connected to a plurality of sub-processors of the at least one display module 110-1, 110-2, . . . , 110-n, and may transmit and receive various data such as input image data, control data or the like to and from the sub-processors.

The processor 130 may obtain the brightness information of the input image data. Here, the brightness information of the input image data may be an average picture level (APL) for each frame of the input image data, as described above. That is, the processor 130 may obtain an average gradation value for at least one pixel included in the image. However, the disclosure is not limited thereto, and the brightness information of the input image may be various types of information that affect the power consumption of the display device 100 while outputting an image. For example, the processor 130 may obtain the brightness information of the input image according to various criteria, such as a maximum gradation value, a maximum gradation value for each R, G, B, a mode gradation value, a mode gradation value for each R, G, B, and maximum brightness information of image, among a plurality of gradation values of the input image.

The processor 130 may obtain a target luminance corresponding to the brightness information of the input image data. Here, the target luminance may be an output image luminance corresponding to the brightness information of the input image. For example, the processor 130 may obtain the output image luminance as the target luminance based on the information on the output luminance for each gradation level corresponding to the average picture level (APL) of the input image data. For example, the processor 130 may determine the target luminance based on the arrangement and number of the at least one display module 110-1, 110-2, . . . , 110-n, and control the peak gain, thereby limiting the output image luminance to the target luminance.

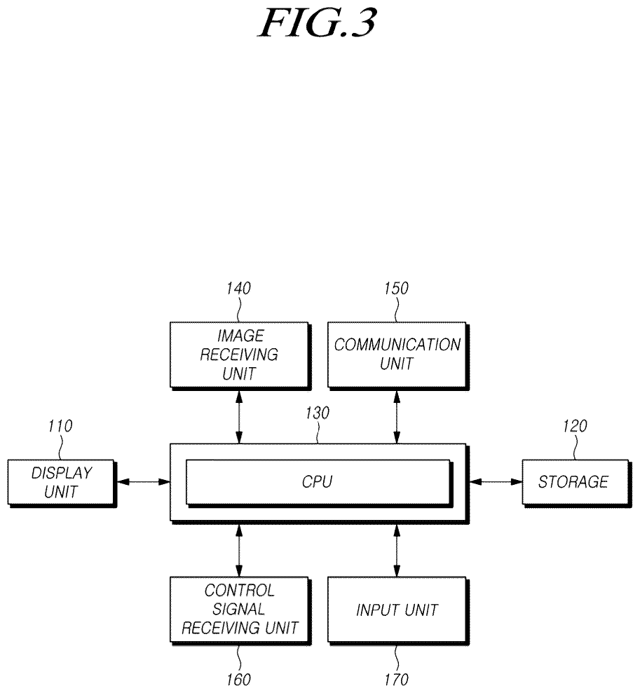

FIG. 3 illustrates a detailed block configuration of a display device.

Referring to FIG. 3, the display device 100 may include a display unit 110, a storage 120, a processor 130, an image receiving unit 140, a communication unit 150, a control signal receiving unit 160, and an input unit 170. Among the components shown in FIG. 3, a detailed description of the components which overlap with the components shown in FIG. 1 will be omitted.

The display unit 110 may provide various content screens through the display device 100. Here, the content screen may include various contents such as images, videos, texts, music, an application execution screen including such various contents, a graphic user interface (GUI) screen, and the like.

Meanwhile, the display unit 110 may be implemented as various types of displays such as a liquid crystal display, an organic light-emitting diode, liquid crystal on silicon (LCOS), digital light processing (DLP), and the like. Further, the display unit 110 may be made of a transparent material to implement a transparent display that displays information. Further, the display unit 110 may be implemented as a self-luminous display such as an organic light-emitting diode (OLED).

Meanwhile, the display unit 110 may be implemented in the form of a touch screen having a layered structure with a touch pad, in which case the display unit 110 may be used as a user interface in addition to an output device.

The storage 120 may be implemented as an internal memory such as ROM or RAM included in the processor 130, or may be implemented as a memory separate from the processor 130. In this case, the storage 120 may be implemented in the form of a memory embedded in the display device 100, or may be implemented in the form of a memory that can be attached to and detached from the display device 100, depending on the purpose of data storage. For example, data for driving the display device 100 may be stored in a memory embedded in the display device 100, and data for extended functions of the display device 100 may be stored in a memory that can be attached to and detached from the display device 100. Meanwhile, the memory embedded in the display device 100 may be implemented in the form of a non-volatile memory, a volatile memory, a hard disk drive (HDD), or a solid state drive (SSD), and the memory attachable to and detachable from the audio output device 100 may be implemented in the form of a memory card (e.g., micro SD card, USB memory), an external memory (e.g., USB memory) connectable to a USB port, and the like.

The processor 130 may control the overall operation of the display device 100 and the signal flow between internal components of the display device 100, and may process data therefor. For example, the processor 130 may include a central processing unit (CPU) for controlling driving of software (e.g., an operating system (OS) and application programs) stored in the display device 100.

For example, the processor 130 may load software stored in the non-volatile memory device into the volatile memory device to drive the software, and control the display device 100 according to a user command received via the input unit 170 or the software being driven.

Further, the processor 130 may include a graphic processing unit (GPU) (not shown) for performing graphic processing corresponding to the video. The processor 130 may be implemented as a system on chip (SoC) adapted to integrate a core and the GPU. For example, the processor 130 may include a single core, a dual core, a triple core, a quad core, and multiples thereof.

The processor 130 may include a plurality of processors. For example, the processor 130 may include a main processor and a sub processor that operates in a standby mode.

The image receiving unit 140 may be implemented as a tuner receiving broadcast images, but the disclosure is not limited thereto, and may be implemented as various types of communication modules capable of receiving various external images (e.g., video), such as Wi-Fi module, USB module, or HDMI module.

Further, the image may be stored in the storage 120, and in such a case, the display device 100 may, of course, adjust and output the gradation level, output luminance, and light quantity for each pixel of the image stored in the storage 120, according to various embodiments of the disclosure.

The communication unit 150 may transmit/receive an image. For example, the communication unit 150 may receive an acoustic signal via streaming or downloading from an external device (e.g., source device), an external storage medium (e.g., USB), an external server (e.g., web hard), and the like, using various communication schemes such as e.g., AP-based Wi-Fi (Wireless LAN network), Bluetooth, Zigbee, wired/wireless LAN (Local Area Network), WAN, Ethernet, IEEE 1394, HDMI, USB, MHL, AES/EBU, Optical, Coaxial, and the like.

Further, the communication unit 150 may receive the output luminance information for each gradation level according to the brightness information of the image, from an external server (not shown). For example, the display device 100 may receive information from the external server to store the same in the storage 120, and may update the stored information based on the information received from the external server. Further, the display device 100 may obtain a weight used to obtain a correction effect from the server.

The control signal receiving unit 160 may receive a control signal transmitted from a control device (e.g., remote control). For example, the control signal receiving unit 160 may include a light receiving unit for inputting an infrared (IR) signal. For example, the control signal receiving unit 160 may receive a control signal by performing communications according to a wireless communication protocol such as Bluetooth or Wi-Fi.

The input unit 170 may be implemented as various buttons provided on a main body of the display device 100. A user may input various user commands such as a turn on/turn off command, a channel change command, a volume control command, and a menu check command, using the input unit 180.

The display device 100 may perform adjustment of the gradation level, output image luminance, and light quantity of the input image data according to various embodiments of the disclosure, in response to a user input to the control signal receiving unit 160 and the input unit 170. For example, the display device 100 may operate in at least one mode of a maximum output mode (or outdoor mode) for increasing the power consumption of the display device 100 upon outputting an image, a standard mode, and a power saving mode (or indoor mode) for reducing the power consumption of the display device 100 when outputting an image.

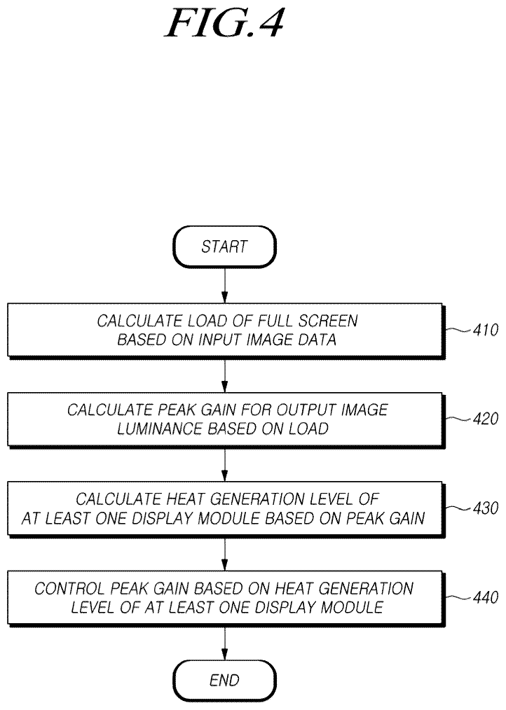

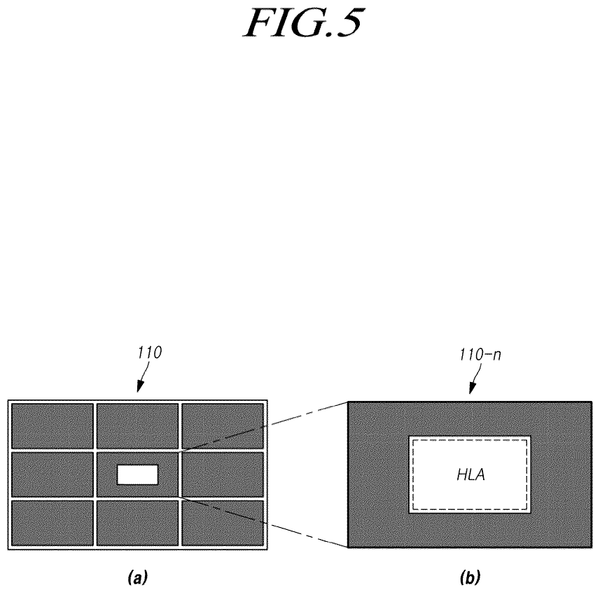

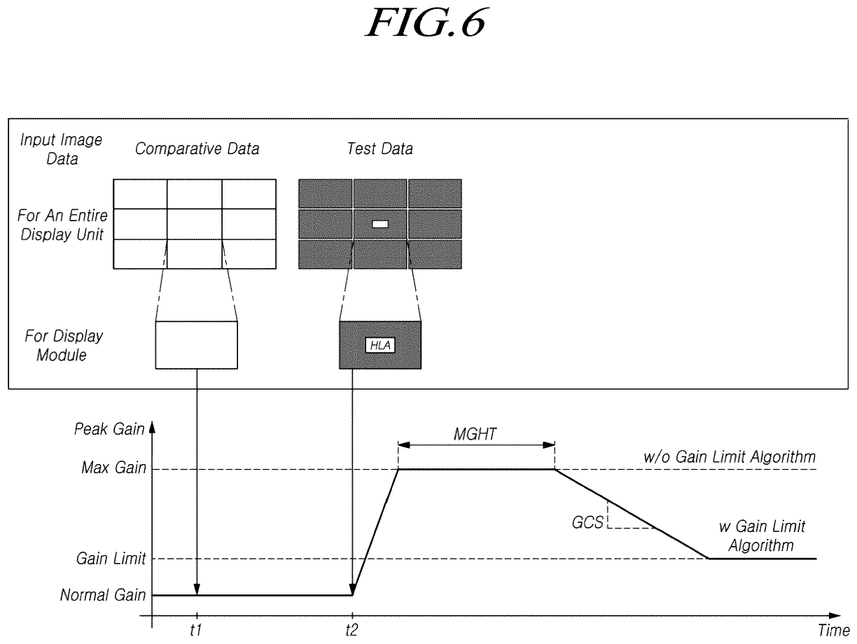

FIG. 4 illustrates an operation sequence of a display device, FIG. 5 illustrates a display module including a high luminance area (HLA), and FIG. 6 illustrates a change in peak gain based on a gain limit algorithm.

Referring to FIG. 4, the display device 100 may calculate a load of a full screen based on input image data (operation 410). The display device 100 may calculate a peak gain for output image luminance based on the load (operation 420). The display device 100 may calculate a heat generation level of the at least one display module based on the peak gain (operation 430). The display device 100 may control the peak gain based on the heat generation level of the at least one display module (operation 440).

According to an embodiment, in operation 410, the display device 100 may calculate a load of a full screen based on input image data. For example, the display device 100 may extract an average picture level of the full screen from the input image data. The average picture level may be an average gradation value for pixel data in one frame unit of the input image data. For example, the display device 100 may calculate the load of the full screen based on the average picture level. The load may be a quantized value of the total amount of brightness that the display device 100 will have to output based on the input image data. For example, the higher the average picture level, the greater the load of the full screen, and the lower the average picture level, the smaller the load of the full screen.

According to an embodiment, in operation 420, the display device 100 may calculate a peak gain for output image luminance based on the load. The peak gain, which is a weight for adjusting the output image luminance, may include a normal gain that minimizes the output image luminance and a maximum gain that maximizes the output image luminance. For example, the display device 100 may calculate the normal gain that minimizes the output image luminance based on the load. For example, the display device 100 may calculate the maximum gain that maximizes the output image luminance based on the load.

According to an embodiment, in operation 430, the display device 100 may calculate a heat generation level of the at least one display module based on the peak gain. As shown in FIG. 5(a), the at least one display module may include a high luminance area (HLA) of a predetermined size. The display device 100 may extract the high luminance area (HLA) of the at least one display module based on the peak gain. For example, the high luminance area (HLA) may have a luminance in the range of 1000 nits to 2000 nits. For example, the high luminance area (HLA) may output a full-white image.

The display device 100 may calculate the heat generation level based on the size of the high luminance area (HLA). For example, the display device 100 may identify the size of the high luminance area (HLA) included in the at least one display module. The display device 100 may calculate a higher heat generation level as the size of the high luminance area (HLA) is larger, and may calculate a lower heat generation level as the size of the high luminance area (HLA) is smaller.

The display device 100 may predict whether the at least one display module exceeds a reference operating temperature by calculating the heat generation level in units of the at least one display module. The reference operating temperature may be the highest temperature at which the at least one display module may display a normal output image. For example, the display device 100 may determine that the at least one display module will exceed the reference operating temperature when the size of the high luminance area (HLA) exceeds about 20% to 25% of the size of the at least one display module.

According to an embodiment, in operation 440, the display device 100 may control the peak gain based on the heat generation level of the at least one display module. The display device 100 may change the output image luminance by controlling the peak gain within the range between the normal gain and the maximum gain. For example, the display device 100 may control at least one of a maximum gain holding time, a gain control slope, and a gain limit, based on the heat generation level of the at least one display module.

The at least one processor of the display device 100 may execute a gain limit algorithm when it is predicted that the at least one display module will exceed the reference operating temperature, based on the heat generation level. For example, the display device 100 may execute the gain limit algorithm for controlling the peak gain when the size of the high luminance area (HLA) exceeds 20% to 25% of the size of the at least one display module.

Referring to FIG. 6, the display device 100 may calculate the normal gain and the maximum gain for the output image luminance based on input image data, and control the peak gain based on the heat generation level of the at least one display module.

According to an embodiment, the input image data (e.g., comparative data) input at a first time point (t1) may include a full-white image. As the input image data at the first time point (t1) includes the full-white image, the overall image of the display unit may exceed the reference operating temperature. As the overall image exceeds the reference operating temperature, the display device 100 may set the peak gain to the normal gain. As the peak gain is set to the normal gain, the output image luminance may be minimized, and the heat generation level may be maintained no higher than the reference operating temperature.

According to an embodiment, the input image data (e.g., test data) at a second time point (t2) may include a high luminance area (HLA) having a luminance in the range of 1000 nit to 2000 nit. The display device 100 may control the peak gain based on the size of the high luminance area (HLA). For example, when the size of the high luminance area (HLA) is no more than 20% to 25% of the size of the at least one display module, the display device 100 may set the peak gain to the maximum gain.

For example, when the size of the high luminance area (HLA) exceeds 20% to 25% of the size of the at least one display module, the display device 100 may change the output image luminance by controlling the peak gain within the range between the normal gain and the maximum gain. For example, the display device 100 may control at least one of the maximum gain holding time (MGHT), the gain control slope (GCS), or the gain limit, within a range that does not exceed the reference operating temperature. For example, the maximum gain holding time (MGHT) may be the time for which the maximum gain is held by the gain limit algorithm. For example, the gain control slope (GCS) may be a value obtained by dividing a difference between the maximum gain and the gain limit by the time required to reach the gain limit from the maximum gain. For example, the gain limit may be the minimum gain for keeping the output image luminance at the target luminance.

As described above, the display device 100 of the disclosure may efficiently control heat generation of the display unit by determining the heat generation level based on each display module, rather than collectively determining the heat generation level on the basis of the full screen, and by adjusting the peak gain considering the arrangement and number of the display modules.

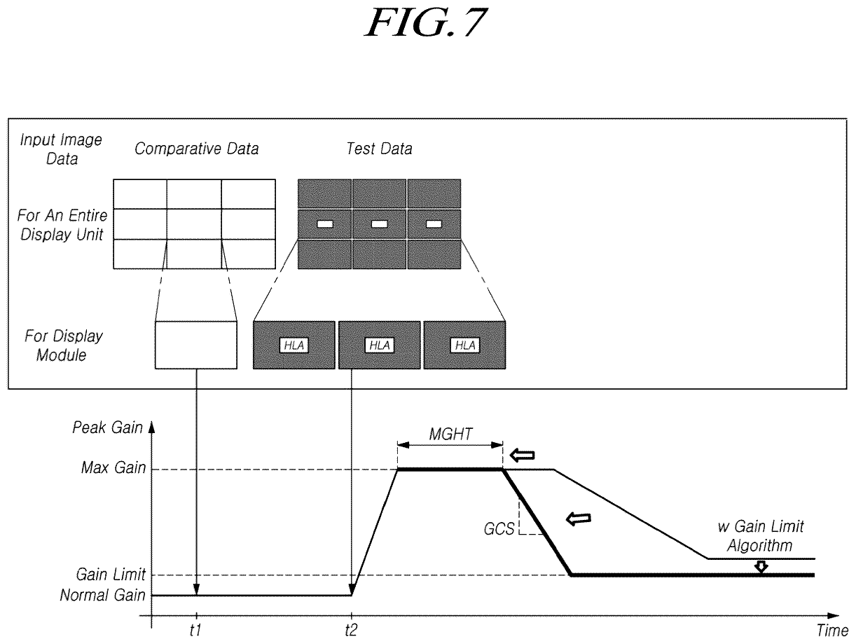

FIG. 7 illustrates a change in peak gain based on a gain limit algorithm according to another embodiment.

Referring to FIG. 7, the display device 100 may calculate the normal gain and the maximum gain for the output image luminance based on the input image data, and control the peak gain based on the arrangement and number of the at least one display module including the high luminance area (HLA). For example, the gain limit algorithm may be changed depending on the arrangement and number of the at least one display module including the high luminance area (HLA).

The display device 100 may predict whether the at least one display module exceeds the reference operating temperature by calculating the heat generation level in units of the at least one display module. The display device 100 may execute the gain limit algorithm when it is predicted that the at least one display module will exceed the reference operating temperature, based on the heat generation level.

According to an embodiment, the gain limit algorithm may decrease the maximum gain holding time (MGHT) as the number of the at least one display modules including the high luminance area (HLA) increases. For example, comparing FIG. 6 and FIG. 7, when the number of the at least one display modules including the high luminance area (HLA) increases from 1 to 3, the gain limit algorithm may minimize the heat generation of the display unit by decreasing the maximum gain holding time (MGHT).

According to an embodiment, the gain limit algorithm may increase the gain control slope (GCS) as the number of the at least one display modules including the high luminance area (HLA) increases. For example, comparing FIG. 6 and FIG. 7, when the number of the at least one display modules including the high luminance area (HLA) increases from 1 to 3, the gain limit algorithm may minimize the heat generation of the display unit by increasing the gain control slope (GCS) to control the peak gain to reach the gain limit faster.

According to an embodiment, the gain limit algorithm may decrease the gain limit as the number of the at least one display modules including the high luminance area (HLA) increases. For example, comparing FIG. 6 and FIG. 7, when the number of the at least one display modules including the high luminance area (HLA) increases from 1 to 3, the gain limit algorithm may minimize the heat generation of the display unit by decreasing the gain limit.

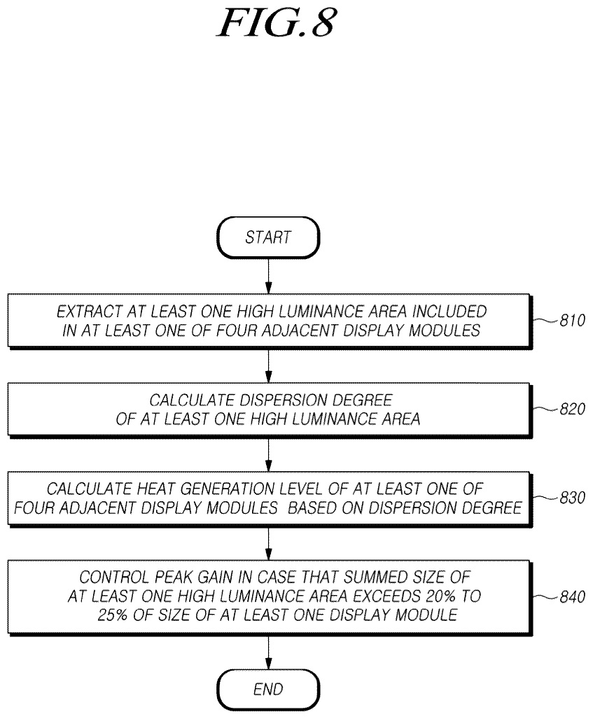

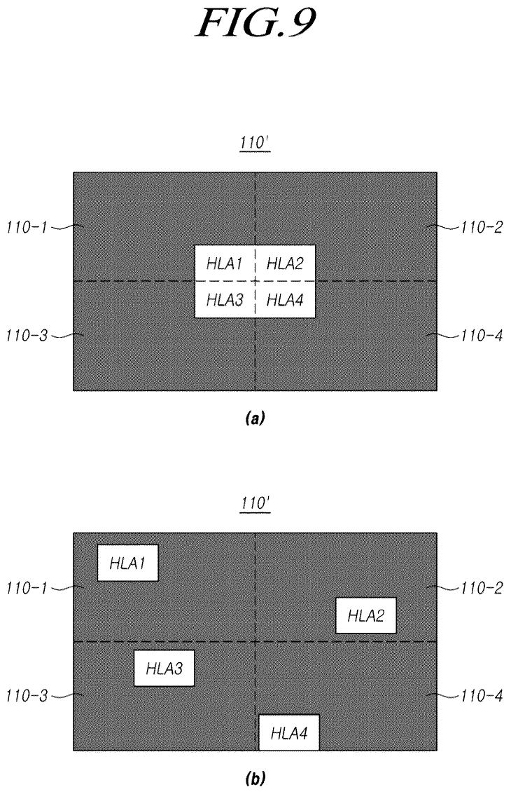

FIG. 8 illustrates an operation sequence of a display device, and FIG. 9 illustrates four adjacent display modules 110-1, 110-2, 110-3, and 110-4 including high luminance area HLA1, HLA2, HLA3, HLA4.

Referring to FIG. 8 and FIG. 9, the display device 100 may calculate a normal gain and a maximum gain for output image luminance based on input image data, and calculate a heat generation level in units of four adjacent display modules. The display device 100 may control a peak gain based on the heat generation level calculated in units of the four adjacent display modules.

According to an embodiment, in operation 810, the display device 100 may extract at least one high luminance area HLA1, HLA2, HLA3, HLA4 included in the at least one of the four adjacent display modules. For example, the display device 100 may group at the least one of the four adjacent display modules 110-1, 110-2, 110-3, 110-4 into one display module group 110′. The display device 100 may extract at least one high luminance area HLA1, HLA2, HLA3, HLA4 having a luminance in the range of 1000 nits to 2000 nits from the display module group 110′.

According to an embodiment, in operation 820, the display device 100 may calculate the dispersion degree of the at least one high luminance area HLA1, HLA2, HLA3, HLA4. For example, the display device 100 may calculate the dispersion degree by quantifying the distribution of the at least one high luminance area HLA1, HLA2, HLA3, HLA4 in the display module group 110′. For example, as shown in FIG. 9(a), when the at least one high luminance area HLA1, HLA2, HLA3, HLA4 are concentrated, the display device 100 may determine that the dispersion degree of the high luminance area HLA1, HLA2, HLA3, HLA4 is relatively low. For example, as shown in FIG. 9(b), when the at least one high luminance area HLA1, HLA2, HLA3, HLA4 are widely dispersed, the display device 100 may determine that the dispersion degree of the high luminance area HLA1, HLA2, HLA3, HLA4 is relatively high.

According to an embodiment, in operation 830, the display device 100 may calculate the heat generation level of the at least one of the four adjacent display modules based on the dispersion degree. The display device 100 may calculate the heat generation level of the display unit 110′ based on a summed size of the at least one high luminance area HLA1, HLA2, HLA3, HLA4 and the dispersion degree of the at least one high luminance area HLA1, HLA2, HLA3, HLA4. For example, the heat generation level may increase as the summed size of the at least one high luminance area HLA1, HLA2, HLA3, HLA4 increases. For example, the heat generation level may increase as the dispersion degree of the at least one high luminance area HLA1, HLA2, HLA3, HLA4 decreases.

According to an embodiment, in operation 840, the display device 100 may control the peak gain based on the heat generation level of the at least one of the four adjacent display modules 110-1, 110-2, 110-3, 110-4. For example, the display device 100 may execute the gain limit algorithm for controlling the peak gain, when the summed size of the at least one high luminance area HLA1, HLA2, HLA3, HLA4 included in the at least one of the four adjacent display modules 110-1, 110-2, 110-3, 110-4 exceeds 20% to 25% of the size of the at least one display module. In other words, even when the size of the high luminance area included in each of the at least one display module is 20% to 25% or less of the size of the at least one display module, when the summed size of the at least one high luminance area exceeds 20% to 25% of the size of the at least one display module and the high luminance areas are concentrated due to the low dispersion degree of the high luminance area, the display device 100 may execute the gain limit algorithm for controlling the peak gain.

As described above, the display device 100 of the disclosure may efficiently control heat generation of the display unit by determining the heat generation level on the basis of each display module, and by considering the arrangement and number of the at least one display module to adjust the peak gain.

Accordingly, the display device 100 of the disclosure may prevent unnecessary peak gain control, and minimize a decrease in luminance of a full image and a decrease in display quality due to the peak control. However, as this has been described above, redundant explanation thereof will be omitted.

Electronic devices according to various embodiments disclosed in this document may be various types of devices. The electronic device may include, for example, a portable communication device (e.g., smart phone), a computer device, a portable multimedia device, a portable medical device, a camera, a wearable device, or a home appliance. The electronic device according to embodiments of the disclosure is not limited to the aforementioned devices.

It should be appreciated that various embodiments of the disclosure and the terms used therein are not intended to limit the technological features set forth herein to particular embodiments and include various changes, equivalents, or replacements for a corresponding embodiment. In conjunction with the description of the drawing, similar reference numerals may be used for similar or related components. A singular form of a noun corresponding to an item may include one or more items unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st”, “2nd”, or “first” or “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled” or “connected” with/to another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic”, “logic block”, “part”, or “circuit”. Such a “module” may be a single integral component, or a minimum unit or a part of the component, adapted to perform one or more functions. For example, the module may be implemented in the form of an application-specific integrated circuit (ASIC).

Various embodiments as set forth herein may be implemented as software (e.g., program) including one or more instructions that are stored in a storage medium (e.g., an internal memory or an external memory) that is readable by a machine (e.g., an electronic device). For example, a processor of the machine (e.g., an electronic device) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to various examples disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A modular display device, comprising:
a display unit including at least one display module;
a storage storing at least one instruction; and
at least one processor executing the at least one instruction,
wherein the at least one processor is configured to:
calculate a load of a full screen based on input image data;
calculate a peak gain for output image luminance based on the load;
calculate a heat generation level of the at least one display module based on the peak gain; and
control the peak gain based on the heat generation level of the at least one display module.

2. The display device of claim 1, wherein the at least one processor is configured to:
predict whether the at least one display module exceeds a reference operating temperature by calculating the heat generation level in units of the at least one display module; and
execute a gain limit algorithm when it is predicted that the at least one display module will exceed the reference operating temperature, based on the heat generation level.

3. The display device of claim 1, wherein the at least one processor is configured to:
extract an average picture level (APL) for the full screen from the input image data; and
calculate the load of the full screen based on the average picture level.

4. The display device of claim 1, wherein the at least one processor is configured to:
calculate a normal gain that minimizes the output image luminance based on the load; and
calculate a maximum gain that maximizes the output image luminance based on the load.

5. The display device of claim 1, wherein the at least one processor is configured to:
extract a high luminance area of the at least one display module based on the peak gain; and
calculate the heat generation level based on a size of the high luminance area.

6. The display device of claim 5, wherein the high luminance area has a luminance in a range of 1000 nits to 2000 nits.

7. The display device of claim 5, wherein the at least one processor is configured to execute a gain limit algorithm for controlling the peak gain when a size of the high luminance area exceeds 20% to 25% of a size of the at least one display module.

8. The display device of claim 7, wherein the at least one processor is configured to control at least one of a maximum gain holding time, a gain control slope, or a gain limit, based on the heat generation level of the at least one display module.

9. The display device of claim 8, wherein the gain limit algorithm is configured to decrease the maximum gain holding time as a number of the at least one display module including the high luminance area increases.

10. The display device of claim 8, wherein the gain limit algorithm is configured to increase the gain control slope as a number of the at least one display module including the high luminance area increases.

11. The display device of claim 8, wherein the gain limit algorithm is configured to decrease the gain limit as a number of the at least one display module including the high luminance area increases.

12. The display device of claim 1, wherein the at least one processor is configured to:
extract at least one high luminance area included in at least one of four adjacent display modules;
calculate a dispersion degree of the at least one high luminance area; and
calculate the heat generation level of the at least one of the four adjacent display modules based on the dispersion degree.

13. The display device of claim 12, wherein the at least one processor is configured to execute a gain limit algorithm for controlling the peak gain when a summed size of the at least one high luminance area included in the at least one of the four adjacent display modules exceeds 20% to 25% of a size of the at least one display module.

14. A method for driving a modular display device, comprising:
calculating a load of a full screen based on input image data;
calculating a peak gain for output image luminance based on the load;
calculating a heat generation level of at least one display module based on the peak gain; and
controlling the peak gain based on the heat generation level of the at least one display module.

15. The method of claim 14, wherein the calculating the load of the full screen comprises:
extracting an average picture level (APL) for the full screen from the input image data; and
calculating the load of the full screen based on the average picture level.

16. The method of claim 14, wherein the calculating the heat generation level of the at least one display module comprises:
extracting a high luminance area of the at least one display module based on the peak gain; and
calculating the heat generation level based on a size of the high luminance area.

17. The method of claim 16, wherein the controlling the peak gain comprises executing a gain limit algorithm for controlling the peak gain when the size of the high luminance area exceeds 20% to 25% of a size of the at least one display module.

18. The method of claim 17, wherein the controlling the peak gain further comprises controlling at least one of a maximum gain holding time, a gain control slope, or a gain limit, based on the heat generation level of the at least one display module.

19. The method of claim 14, wherein the calculating the heat generation level comprises:
extracting at least one high luminance area included in at least one of four adjacent display modules;
calculating a dispersion degree of the at least one high luminance area; and
calculating the heat generation level of at least one of the four adjacent display modules based on the dispersion degree.

20. A non-transitory computer-readable storage medium storing instructions that, when executed by at least one processor, cause the at least one processor to perform operations comprising:
calculating a load of a full screen based on input image data;
calculating a peak gain for output image luminance based on the load;
calculating a heat generation level of at least one display module based on the peak gain; and
controlling the peak gain based on the heat generation level of the at least one display module.
